(19) United States
(12) Patent Application Publication
(10) Pub. No.: US 2011/0011053 A1
(43) Pub. Date: Jan. 20, 2011

(54) Adiabatic external combustion with low pressure positive displacement motor

(76) Inventor: Roger A. Benham, San Diego, CA (US)

Correspondence Address: Welsh Flaxman & Gitler, 2000 Duke Street , Suite 100, Alexandria, VA, 22314, US

(21) Appl. No.: 12/805,107

(22) Filed: Jul. 13, 2010

Related U.S. Application Data
(63) Continuation-in-part of application No. 12/659,835, filed on Mar. 23, 2010.
(60) Provisional application No. 61/213,782, filed on Jul. 14, 2009.

(51) Int. Cl. F02B 43/00

(52) U.S. Cl. 60/39.63

(57) ABSTRACT

The present invention relates to a method and device using an external combustion apparatus to supply large amounts of heated and pressurized combustion gases used to produce mechanical movement of a device, such as, but not limited to, a piston or a low pressure positive displacement motor. The combustion takes place in a separate pressurized combustion vessel that is supplied with organic fuel and two separate streams of compressed air, one from a lower pressure air receiver and one from a higher pressure air receiver. The combustion gases from igniting the fuel with the higher pressure air stream are accelerated and blended with the lower pressure air stream in a manner to produce a mixture of higher temperature pressurized working gas. The design includes features of regenerative cooling of the combustion vessel, improved combustion characteristics, regenerative breaking, and higher efficiency.

### CROSS-REFERENCE TO RELATED APPLICATIONS

The present invention claims the benefit of the filing date of U.S. provisional patent application Ser. No. 61/213,782, filed Jul. 14, 2009. The present invention is also a continuation-in-part of U.S. patent application Ser. No. 12/659,835, filed on Mar. 23, 2010, and incorporates the subject matter therein by reference.

### FIELD OF THE INVENTION

The present invention relates to a means of using an external combustion apparatus to supply large amounts of heated and pressurised combustion gases to an output device, such as, but not limited to, a low pressure-gradient positive displacement motor to provide a pressure differential on opposing sides of a membrane in the motor to produce a rotational power output.

### BACKGROUND OF THE INVENTION

In conventional combustion apparatus, such as those used to provide the driving force to vehicles and the like, the combustion apparatus is an engine in which combustion takes place internally to the engine.

While engines of this kind have become widely used, they suffer from a number of drawbacks, including their bulky size, poorer efficiency, higher fuel consumption, higher level of hazardous emissions (such as nitrous oxides and carbon monoxide) and the higher cost of construction. In addition, conventional internal combustion engines are adapted to run on a single type of fuel only, making them relatively inflexible.

Some attempts have been made to overcome these drawbacks. For instance, a number of external combustion apparatuses have been developed in which a motor (or similar device) is powered using energy generated in a combustion apparatus located externally to the motor. However, these devices suffer from the drawbacks of having lower efficiency (including failing to recover waste heat), require combustion to occur at high temperatures, require cooling and do not provide for such typical vehicle conditions such as idling or instant starting.

Thus, there would be an advantage to provide an external combustion apparatus that demonstrated relatively high efficiency, relatively low emissions and was capable of being operated using multiple types of fuel.

External combustion and pressure driven devices designs all have their shortcomings. The present invention is designed to create an improved external combustion and pressure driven motor device to help overcome the disadvantages of the existing art.

Some benefits include:
More compact power source
Lower NOx and CO emissions
Higher efficiency
Lower fuel consumption
Multi-fuel capability
Elimination of cooling requirement
Regenerative braking
No idling and Instant starting
Waste heat recovery
Low cost materials of construction
Computer controlled operation

All of these features are important to create an improved method and apparatus to produce clean and reliable power from combustible energy sources. This results in more options for the consumer and a cleaner environment.

### SUMMARY OF THE INVENTION

The present invention is directed to an improved external combustor and device for providing pressurized gas to conduct work, such as, but not limited to, driving a low-pressure-gradient positive displacement motor to produce rotational power output. For example, the external combustor described can provide heated and pressurized gas to any pressure-driven motor such as a rotary gear, rotary vane, turbine, or piston driven motor. Additionally, the external combustor and the low pressure-gradient positive displacement motor can be combined to produce a device for energy storage and regenerative braking, which may at least partially overcome the deficiencies in the prior art or provide the consumer with a useful or commercial choice.

The combustion takes place in a separate pressurized combustion vessel that is supplied with a liquid, solid, gas or combination thereof organic fuel and two separate streams of compressed air, one from a lower pressure air compressor and one from a higher pressure air compressor. The combustion gases produced by igniting the fuel with the higher pressure air stream are accelerated and blended with the lower pressure air stream in a manner to produce a mixture of a high temperature pressurized working gas. The design includes features of regenerative cooling of the combustion vessel, improved combustion characteristics, and higher efficiency. In the preferred embodiment, the device for providing the compressed air to the lower and higher pressure air receivers is accomplished by an axial or screw-type compressor interconnected to a demand-controlled continuously variable transmission driven by the output motor, an ancillary motor, or the driving or braking force of the drivetrain of a vehicle. Usable power is produced by combining the blended combustion products from the external combustion apparatus to a low pressure-gradient positive displacement motor to produce rotational power output.

It is an object of the present invention to provide a combustion apparatus which may overcome at least some of the abovementioned disadvantages, or provide a useful or commercial choice.

One aspect of the invention resides broadly in a combustion apparatus comprising a combustion vessel, an upper inlet for a lower pressure blending gas stream, a lower inlet for a higher pressure combustion gas stream and a fuel, and an outlet through which exhaust gases exit the vessel, wherein the exhaust gases are generated at least partially by the reaction of the high pressure combustion gas stream with the fuel in the vessel.

The combustion vessel may be of any suitable size, shape or configuration. For instance, the size and shape of the combustion vessel may be determined by the duty for which the combustion apparatus is intended to be used. If the combustion apparatus is intended to be used for providing a driving force for large vehicles, the combustion vessel may be necessarily larger than if the combustion apparatus is intended to be used for providing a driving force for smaller vehicles.

Preferably, the combustion vessel is fabricated so as to be able to withstand the elevated pressures and temperatures that are likely to be encountered in the combustion apparatus. Thus, one possessing ordinary skill in the art will understand that the materials used, and construction of, the combustion vessel will be selected on the basis of (among other things) their pressure and heat resistance properties.

The upper inlet may be of any suitable type or configuration. Preferably, however, the upper inlet is adapted to provide an entry for the lower pressure gas stream into the combustion vessel such that the lower pressure gas stream rotates within the combustion vessel at or adjacent an inner surface of the combustion vessel. In some embodiments of the invention, the upper inlet is adapted to provide an entry point for the first lower pressure gas stream that is tangential to the wall of the combustion vessel. In this embodiment of the invention, it is preferred that the combustion vessel is substantially cylindrical so as to provide the most suitable vessel geometry for the lower pressure gas stream to rotate within the combustion vessel at or adjacent an inner surface of the outer wall of the vessel. In this way, the lower pressure gas stream may form a curtain or skirt of gas adjacent the inner surface of the outer wall of the vessel, thereby cooling the outer wall of the combustion vessel. In addition, a constant flow of the lower pressure gas stream through the upper inlet ensures that the regenerative cooling of the inner flow skirt of the combustion vessel occurs due to no recycling of the lower pressure blending gas stream taking place.

In a preferred embodiment of the invention, the combustion vessel may be provided with one or more walls located at the interior of the vessel. Preferably, the one or more walls are positioned so as to ensure that the lower pressure gas stream is retained adjacent the inner surface of the outer wall of the combustion vessel for at least a portion of the height of the combustion vessel.

In some embodiments of the invention, it is preferable that the upper inlet is provided in an upper portion of the combustion vessel. In these embodiments of the invention, it is preferred that the lower pressure blending gas stream that enters the combustion vessel in an upper region thereof passes along a substantial portion of the height of the vessel before it exits the vessel through the outlet. Thus, the combustion vessel may be provided with one or more diversion means adapted to divert the flow of the lower pressure blending gas stream along a substantial proportion of the height of the vessel without the lower pressure blending gas stream short-circuiting to the outlet. Any suitable diversion means may be provided to direct the lower pressure blending gas stream between the upper inlet and the outlet along a substantial portion of the height of the vessel, although it is preferred that a physical barrier to prevent short-circuiting of the blending gas stream to the outlet is employed. For instance, a wall (or similar physical barrier) may be provided inside the combustion vessel at a point above the upper inlet such that the only direction in which the blending gas stream is able to travel is downwardly in the vessel. Similarly, a wall may be provided at a point below the upper inlet if the upper inlet is located in a lower region of the vessel to ensure that the blending gas stream may travel in an upward direction only.

In embodiments of the invention in which the upper inlet is located in an upper region of the combustion vessel, and the lower pressure blending gas stream is forced to travel downwardly within the combustion vessel, it is preferred that the one or more internal walls ends at a point above the floor of the combustion vessel such that the blending gas stream may travel under the lower edge of the wall and enter a main chamber of the combustion vessel. Upon entering the main chamber of the vessel, the lower pressure blending gas stream may then flow to the outlet of the combustion vessel.

In a preferred embodiment of the invention, the higher pressure combustion gas stream and fuel entering the main chamber of the combustion chamber vessel enter through an igniter manifold located at the lower inlet of the combustion vessel. While it is envisioned that the lower inlet could be located at any suitable point within the vessel, it is preferred that the lower inlet is located in a lower region of the combustion vessel. In a particular embodiment of the invention, the lower inlet may be located in the floor of the vessel. The higher pressure combustion gas stream and fuel entering the combustion vessel through the igniter manifold located at the lower inlet may enter the vessel at any suitable angle, however it is preferred that the higher pressure combustion gas stream and fuel enter the combustion vessel and flow upwardly through the combustion vessel to the outlet. The ratio of fuel to higher pressure combustion gas stream entering the combustion vessel through the lower inlet may be constant, or may be variable. In a preferred embodiment of the invention, the ratio of fuel to a second (high pressure) combustion gas stream entering the combustion vessel through the second inlet may be varied depending on the purpose and duty of the combustion apparatus. Thus, the fuel to the second (high pressure) combustion gas stream mixture may be varied between fuel-rich, fuel-lean and stoichiometric ratios of fuel to second combustion gas stream.

The higher pressure combustion gas stream and the fuel may be combined prior to entering the vessel such that a combined fuel/ higher pressure combustion gas stream enters through the lower inlet. Alternatively, the higher pressure combustion gas stream and the fuel may be combined in a passageway leading to the lower inlet using any suitable technique (such as a Venturi effect to draw the fuel into the lower inlet). In other embodiments of the invention, the lower inlet may be provided with an inlet passageway, the inlet passageway having a fuel inlet and a higher pressure combustion gas stream inlet. In this embodiment of the invention, the fuel and higher pressure combustion gas stream may be allowed to combine at any suitable point within the inlet passageway. However, in a preferred embodiment of the invention, the fuel and higher pressure combustion gas stream may only be combined at or near the point of entry into the combustion chamber. In this way, any premature reaction of the fuel and higher pressure combustion gas stream may be prevented. This may be important both from a safety point of view, and in terms of ensuring that as much energy generated by the reaction of the fuel and the higher pressure combustion gas stream is captured within the combustion vessel.

The reaction between the fuel and the higher pressure combustion gas stream may be, for instance, a naturally-occurring exothermic chemical reaction. Alternatively, the reaction of the fuel and gas stream may require the input of energy in order to begin. In this embodiment of the invention, the combustion vessel may be provided with energy input device adapted to provide the required energy to start the reaction between the fuel and the higher pressure combustion gas stream. Preferably, the energy input device is located at or adjacent the lower inlet (or inside the inlet passageway, if present) such that the reaction between the fuel and the higher pressure combustion gas stream commences just as, or just prior to, entry of the higher pressure combustion gas stream and fuel into the combustion vessel through the lower inlet.

The energy input device may be of any suitable type. For instance, the energy input means may be adapted to input microwave energy, UV energy, infrared energy, heat energy, frictional energy or the like, or any combination thereof into the higher pressure combustion gas stream/fuel mixture. In a preferred embodiment of the invention, the energy input device is adapted to input heat energy into the higher pressure combustion gas stream/fuel mixture using any suitable heat source. In a most preferred embodiment of the invention, the energy input device comprises one or more burners, spark igniters (particularly electronic spark igniters) or the like, or a combination thereof.

In preferred embodiments of the invention, as the mixture of fuel and the higher pressure combustion gas stream passes the energy input device, the energy input by the energy input means causes a reaction to occur. For instance, the energy input by the energy input means may cause the fuel and higher pressure combustion gas stream mixture to combust.

In a preferred embodiment of the invention, the lower inlet is further provided with constricted portion between the energy input device and the point at which the fuel/higher pressure combustion gas stream mixture enters the combustion vessel. Any suitable constricted portion may be provided. For instance, the constricted portion may simply be a narrowed region of the lower inlet or the inlet passageway if present. The constricted portion is adapted to increase the velocity and lower the pressure of the fuel and second (higher pressure) combustion gas stream mixture as it enters the combustion vessel.

Alternatively, the constricted portion may be in the form of one or more nozzles adapted not only to increase the velocity and pressure of the fuel/higher pressure combustion gas stream mixture as it enters the combustion vessel, but also to impart an angular flow (for instance, a swirling flow) to the fuel/higher pressure combustion gas stream mixture as it enters the combustion vessel.

Preferably, as the fuel/higher pressure combustion gas stream mixture enters the main chamber of the combustion vessel, it combines with the lower pressure blending gas stream. Additional combustion may occur in the main chamber, particularly if the fuel/second combustion gas stream mixture is fuel-rich.

It is preferred that the combined exhaust gas stream that leaves the combustion vessel through the outlet is at a controlled elevated temperature. The hot, pressurized exhaust gas stream may then be used to drive any suitable device that requires a combustion reaction as a driving force, such as a vehicle (cars, trucks, buses, agricultural machinery, boats, aeroplanes or the like), fixed machinery and plant equipment (for instance, that used in mining, industrial and manufacturing plants, power generation plants and the like) and so on. For instance, the exhaust gases may be provided to a low pressure-gradient positive displacement motor.

The exhaust gases may be provided directly to another device requiring a combustion reaction as a driving force, or it may first pass through a conditioning apparatus. A conditioning apparatus may be provided to condition one or more of the temperature, pressure, noise, energy, and flow characteristics of the exhaust gases in order to ensure that the exhaust gases provided to the device requiring a combustion reaction as a driving force are consistent in terms of their characteristics and flow properties.

In a preferred embodiment of the invention, the outlet may be provided at an angle tangential to the outer wall of the combustion vessel. In another preferred embodiment, the outlet may be in the form of an outlet passageway that extends outwardly from the combustion vessel, wherein the exhaust gases flow along the outlet passageway for delivery to a device for use or, for instance, to a conditioning apparatus.

In some embodiments of the invention, the combustion vessel may be provided with a pressure relief device. In this way, if the pressure inside the combustion vessel reaches a predetermined upper limit, the pressure relief device may be activated in order to reduce the pressure within the combustion vessel, thereby preventing damage to the apparatus, or an explosion, or the like. Any suitable pressure relief device may be provided, such as but not limited to, one or more seals, valves, springs or the like that is activated when the pressure reaches a predetermined level, thereby causing depressurization of the combustion vessel.

The lower pressure blending gas stream and the higher pressure combustion gas stream may comprise any suitable gas. The lower pressure blending gas stream and the higher pressure combustion gas stream may comprise the same gas, or different gases to one another. In a preferred embodiment of the invention, however, the first and second gas streams comprise the same gas. Preferably, the gas is a gas that, when combusted in the presence of the fuel, provides an exhaust gas having a high calorific value. Thus, in some embodiments of the invention, the two combustion gas streams may be air (for instance, compressed air), oxygen or the like.

This difference in pressure between the first and second gas streams may be achieved by making use of separate gas sources (e.g. one relatively high pressure source and one relative low pressure source) or, alternatively, making use of a single gas source which is split into a high pressure storage vessel and a low pressure storage vessel, for instance by dividing the gas source so that a portion passes through a low pressure compressor and a portion passes through a second high pressure compressor.

The division of gas from the gas source between the high pressure compressor and the low pressure compressor (and subsequent driving of the high pressure compressor and the low pressure compressor) may be achieved using any suitable technique. However, in a preferred embodiment of the invention, the supply of power to the high pressure and low pressure compressors may be achieved using a drive means, such as a motor or, alternatively, a force generated by the vehicle or device being driven by the combustion apparatus, or regenerative braking to send compressed gas to a storage vessel. Preferably, the power is supplied to the high and low pressure compressors only as required. For instance, there may be periods when the combustion apparatus is used to accelerate a vehicle and the compressors are disengaged.

Any suitable fuel may be used. However, it is preferred that the fuel is an organic fuel. Thus, the fuel may be a gaseous fuel (such as methane, ethane, butane or the like), a liquid (LPG, LNG, gasoline, diesel, fuel oil, kerosene or the like) or a solid fuel (such as coal, coke, wood or the like) or any combination thereof. A skilled practitioner will understand that there may be other organic fuels which may also be suitable for use in the combustion apparatus of the present invention.

With the foregoing in view, the present invention in one form, resides broadly in a pressurized combustion vessel that uses three inputs and one output. The first input is for an organic fuel or reducing agent, the second input is a higher pressure compressed oxidizer gas, namely compressed air, to react with, or combust, the organic fuel. The third input is for a stream of blending gas, namely compressed air, that is at a lower pressure then the second input to provide secondary combustion gas (oxidizer) and regenerative cooling to the outer wall of the combustion vessel by means of an inner flow skirt that channels the circumferential flow of the lower pressure blending stream inside of an annulus created between the pressurized combustion vessel and the inner flow skirt. The lower pressure blending stream of blending gas joins with the combustion gases in a central area of the pressurized combustion vessel, where, due to the directional control of the gases, have a high value of tangential velocity. The hot combustion gases continue to spin and mix as they travel along the central axis of the combustion vessel and exit the combustion vessel at the single output. The hot pressurized gas is then used to drive a pressure driven motor, such as the previously described low pressure-gradient positive displacement motor.

The source of the higher and lower pressure compressed air for the two compressed air streams are at least two air receivers that are kept pressurized by a series of at least two axial flow or screw-type compressor interconnected to a continuously variable transmission driven by the output motor or by the driving or braking force of the drivetrain of a vehicle.

Various configurations, modifications, and additions can be added to modify and improve the operating characteristics of this invention. For example, various computer and electronic flow controls and fixtures can be used to measure and adjust the pressures and flows according to various input or output parameters, or the placement of different clutch configurations and flow diversions and routes can be used.

### BRIEF DESCRIPTION OF THE DRAWINGS

Various embodiments of the invention and appurtenances will be described with reference to the following drawings, in which:

FIG. 1 shows one embodiment of the complete cycle and components comprising an external combustor, compressors, a series of variable speed transmissions, storage tanks for air at higher and lower pressure, an outlet heat transfer and flow buffer, controls, and pressure driven motor;

FIG. 2 shows a sectioned view of the external combustion device;

FIG. 3 shows a view of the flow pattern looking down from the top of the external combustor;

FIG. 4 illustrates the adiabatic characteristics of the complete cycle where all the heat generation and heat transfer produced by the specific components are conserved and no cooling is required;

FIG. 5 shows one embodiment of the complete cycle configured with a low pressure-gradient positive displacement motor as the output power mechanism; and

FIGS. 6A, 6B and 6C show three stages of the operation of the low-pressure-gradient positive displacement motor including top-dead-center, bottom-dead-center, and half-way through the exhaust stroke.

### DETAILED DESCRIPTION OF THE PREFERRED EMBODIMENT

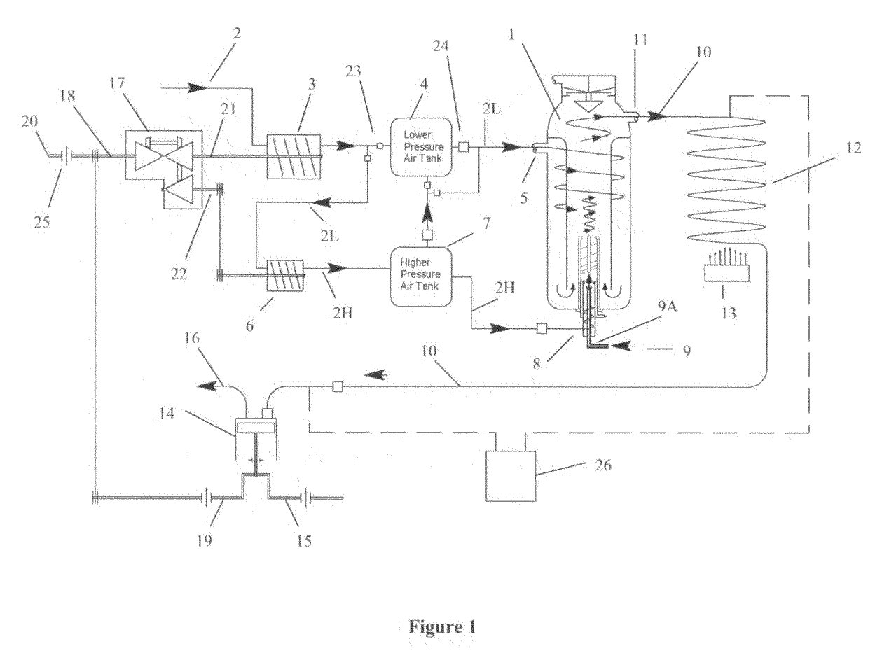

With reference to FIGS. 1 through 6A, 6B and 6C, the present invention will be explained.

FIG. 1 shows a diagram of a preferred embodiment of the external combustion device or combustor 1 and a collection of ancilliary components.

As shown in FIG. 1, a preferred configuration of the invention includes an air supply 2 that enters a lower pressure compressor 3 and exits as a compressed air supply that is directed to a pressurized storage tank 4. A portion of the pressurized air exiting from the supply tank 4 would then enter a pressure inlet 5 provided in an upper portion of the external combustor 1. Preferably, air entering the inlet 5 would enter the external combustor 1 tangentially to produce and spiralling flow pattern.

As shown in FIG. 1, a portion of the compressed air 2L exiting the compressor 3 would be diverted to a higher pressure compressor 6 and exits as a higher pressure compressed air supply 2H that is directed to a high pressure compressed air storage tank 7. It is noted that the compressed air exiting the compressor 3 and stored in storage tank 4 is at a lower pressure than the air 2H exiting the compressor 6 and stored in storage tank 7. The higher pressure compressed air supply 2H then exits the storage tank 7 and is directed through a higher pressure inlet 8 into a lower portion of the external combustor 1. The higher pressure air supply 2H is then mixed with an organic fuel 9 supplied through an interconnecting fuel supply port 9A. The higher pressure air supply 2H and the organic fuel mixture will combust within the to lower portion of the external combustor 1, as will be subsequently explained, and the combusted mixture of the higher pressure air supply and the organic fluid 9 combine with the lower pressure air supply 2L within the external combustor 1.

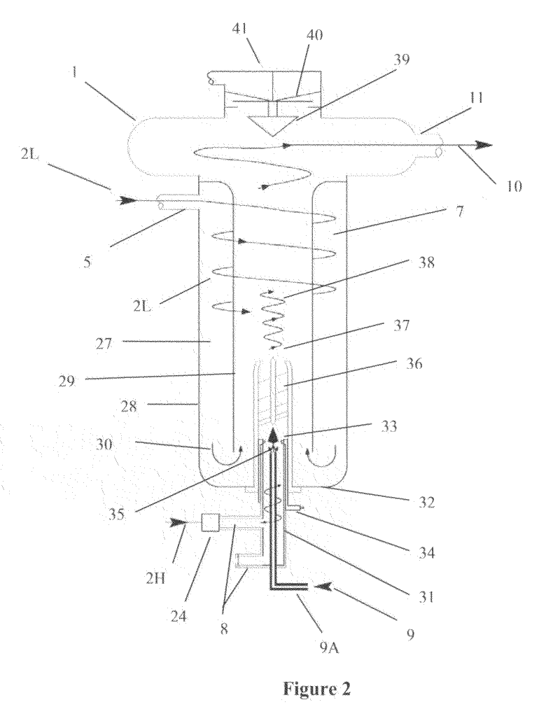

As shown in FIG. 1, after the two streams of air supply 2L and 2H and the organic fuel 9 are combusted, details of which are provided later in the description of FIG. 2, hot pressurized gas 10 exits the external combustor 1 at the external combustor outlet 11. After exiting the external combustor 1 the hot gases 10 enter an ancillary combustion conditioner 12. The combustion conditioner 12 allows time and direction for the hot gases 10 to become more laminar in flow characteristics, resulting in a harnessing of the acoustic noises and turbulence energies into additional gas volume, and allows for ancillary heat transfer either to, or from, the hot gases 10 by means of an ancillary heat exchanger 13.

As shown in FIG. 1, after exiting the ancillary combustion conditioner 12 the hot pressurized gas 10 enters a pressure driven motor 14, where an output shaft 15 delivers rotational work energy to where it is needed, for example to drive the wheels of automobile. After the energy of the pressurized hot gas 10 is expended in the pressure driven motor 14 it is released out of an exhaust port 16.

Also shown in FIG. 1 is a preferred embodiment of the mechanical drive components of the present invention. A multi-output transmission 17 is configured to transmit input power from a rotating input shaft 18 to either or both the lower pressure compressor 3 or the higher pressure compressor 6. The power to drive the multi-output transmission 17 could come from an power take-off shaft 19 from the pressure driven motor 14, an input shaft 20 configured to a drivetrain, regenerative braking (not shown), or an ancillary power unit such as an electric motor (not shown).

As shown in FIG. 1, a lower pressure transmission output shaft 21 is connected to the lower pressure compressor 3. A higher pressure transmission output shaft 22 is connected to the higher pressure compressor 6. The multi-output transmission 17 would preferably be configured with a continuously variable gearing to perfectly match the compressor outputs to the pressurized air 2 demands of the external combustor 1, including acceleration, deceleration (regenerative braking), idle (no ideal, or air supply tank re-pressurizing), and straight and level cruising. Examples of typical loading conditions are provided later in this application.

As shown in FIG. 1, this preferred embodiment of the invention is configured with a series of valves 23, flow controls 24, and clutch mechanisms 25 that would be configured to optimized pumping and flow requirements for all operating conditions, and would be controlled by electronic components and computers. Also provided as an example is the configuration of a controller 26 that monitors demand by means of interpreting the pressure differential between two points in the circuit. Examples of general operating conditions are provided later in this application.

FIG. 2 shows a closer view of one preferred embodiment of the external combustor 1. The lower pressure air supply 2L enters the external combustor 1 through the lower pressure inlet port 5 that is configured with a tangential entry angle that imparts angular or rotational velocity to the lower pressure air supply 2L. The path of the rotational air supply 2L is dictated by an annular space 27 that exists between an outer wall 28 and an inner barrier wall 29. The path of the lower pressure air supply 2L enters the annular space 27 and continues in a downward spiral around the annular space 27 until it reaches the bottom 30 of the inner barrier wall 29, forcing the lower pressure air supply 2L to make a directional change and travels, while maintaining angular momentum, upward toward the upper portion of the external combustor 1 in the direction of the outlet 11.

As shown in FIG. 2, the higher pressure air supply 2H that enters though the higher pressure inlet port 8 installed into an igniter manifold 31 provided in the bottom endcap 32 of the external combustor 1. The higher pressure air supply 2H enters the igniter manifold 31 then mixes with fuel 9 from the fuel supply port 9A and is then ignited by an electronic spark igniter 33, 34, forming a primary flame 35. This primary flame can be fuel-rich, fuel-lean, or stoichiometric. The primary flame 35 then travels upwardly through a stator nozzle 36, preferably made of a ceramic material, that imparts an angular flow velocity at the primary flame exit 37.

At the point of the primary flame exit 37, the pressure of the primary flame 35 has dropped due to the extremely high velocity imparted to the primary flame flow and the resistance pressure drip caused by the stator nozzle 36. At this point the pressure of the primary flame 35 should be slightly higher or equal to the pressure of the low pressure air supply 2L, and the two mix together in a mixing swirling pattern 38, combining to form the hot pressurized gas 10 that exits the outlet 11 to conduct work.

It is noted that in a fuel-rich mixture there would be additional combustion in the mixing swirling pattern 38 region. The higher temperatures in this region would be isolated from the walls of the inner barrier walls 29 due to the tendency of the hot gasses being centrifuged toward the center of the swirling pattern 38. The excess cooler, lower pressure air supply 2L would tend to be centrifuged toward the outer circumference. The outer wall 28 of the external combustor 1 would be further isolated from the hot combustion gases in the swirling pattern 38 by the lower pressure air supply 2L in the annulus space 27.

Also shown in FIG. 2 is a pressure relief system 39 that activates if the pressure becomes too high in the external combustor 1. In the event the pressure becomes too high a pressure relief spring 40 yields and allows the external combustor to depressurize through pressure relief outlet 41.

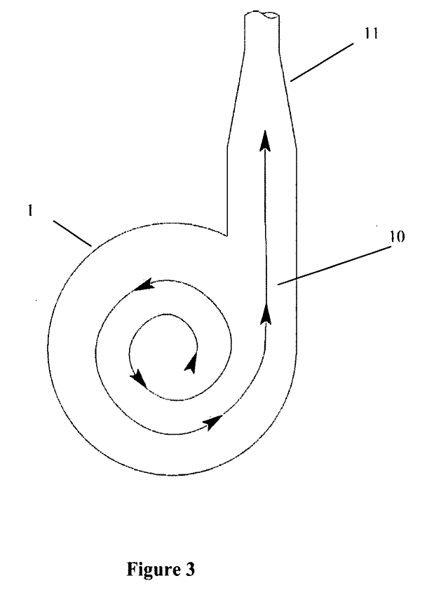

FIG. 3 shows one embodiment of external combustor 1 showing the top view of the flow pattern and the rotational velocity of the of the hot pressurized gases 10 exiting the external combustor 1 through the external combustion outlet 11

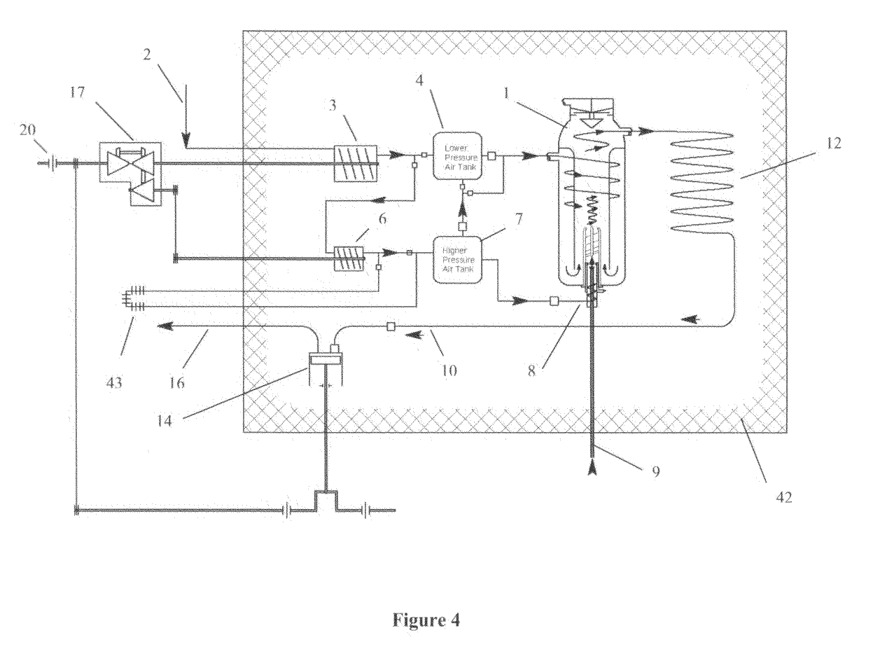

FIG. 4 illustrates the adiabatic characteristics of a complete cycle where all the heat generation and heat transfer produced by the specific components are conserved and no cooling is required. Under any load condition, assuming that the materials of construction can operate under the working temperature of the systems, there is a conservation of heat energy inside a hypothetical thermal insulation 42 and none of the components of the system need cooling during operation. The principal of the no cooling requirement (inherent cooling) is similar to the operation of a commercially available air-motor, wherein no cooling is required because the expansion of the compressed air supply removes any heat that is generated by friction. In the case of where regenerative braking or “engine braking” is used to produce compressed air in the air tanks, an ancillary compressed air cooler 43 could be used to dump waste heat.

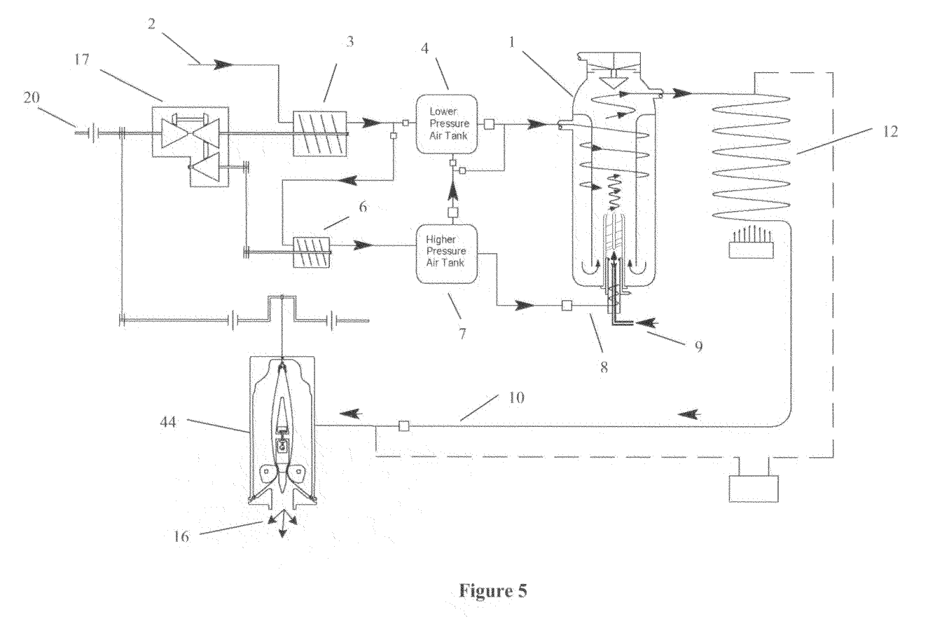

FIG. 5 shows one embodiment of the complete cycle configured with a low pressure positive displacement motor as the output power mechanism. The operation of this system is identical to that shown in FIG. 1. However, instead of using a traditional piston and cylinder mechanism 14 to convert the pressurized gas to usable rotational power output, a low pressure-gradient positive displacement motor 44 is used.

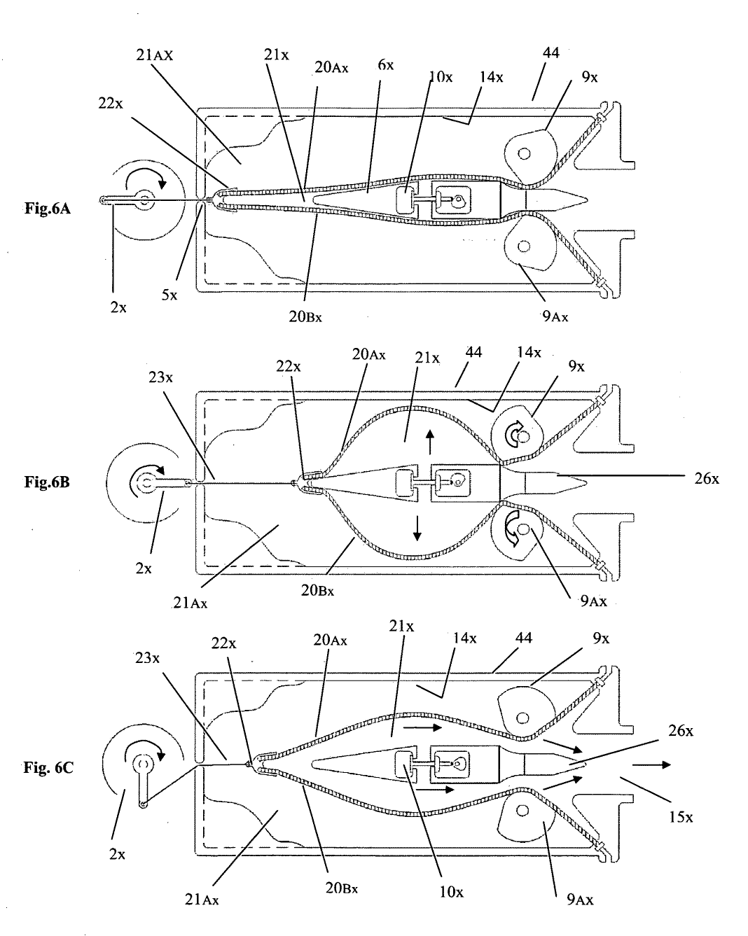

FIGS. 6A through 6C show the operations of the low pressure-gradient positive displacement motor. The principal of operation of the embodiment shown in FIG. 6A through 6C are described in the non-provisional application submitted by the inventor, filed Mar. 23, 2010, and assigned Ser. No. 12/659,835. The subject matter is incorporated by reference. A preferred embodiment of the invention shows two opposing membranes 20Ax and 20Bx creating a continuous double expansion zone 21x between members 20Ax and 20Bx. Three positions of the crankshaft 2x rotation are shown, including top-dead-center (FIG. 6A), bottom-dead-center (FIG. 6B), and a point of rotation half way through the exhaust stroke (FIG. 6C).

As shown in FIG. 6A and FIG. 6B, the two opposing membranes 20Ax and 20Bx are joined together at a travelling yoke 22x assembly that maintains a dynamic leak free seal between the pressurized double expansion zone 21x and the non-pressurized and vented zone 21Ax in the crankcase 14x. It is noted that there are different configurations shown in the non-provisional application Ser. No. 12/659,835, filed Mar. 23, 2010, such as not requiring the use of a travelling yoke, if various methods are used to pinch the two bands together. A flexible connecting membrane 23x is connected between a crankshaft 2x and the travelling yoke 22x. The tension on the connecting membrane 23x is twice the tension on the opposing membranes 20Ax and 20Bx. The connecting membrane 23x can be routed to the crankshaft circuitously through a series of cables and pulleys. The configuration of the two opposing membranes 20Ax and 20Bx has inherent balancing benefits, allowing the acceleration and deceleration forces caused by the up and down components of motion cancel each other out.

FIG. 6C shows an embodiment in which the placement of an aerodynamically shaped exhaust tail 26x in the exhaust port 15x that produces a lower flow resistance of the exhaust fluids. In the embodiment shown, the high pressure supply inlet port 10x allows exhaust gases produced by the external combustor 1 to enter the low pressure-gradient positive displacement motor from the side of a base plate 6x. It is noted that the base plate 6x can be simplified or omitted entirely with the configuration of two opposing membranes shown in Ser. No. 12/659,835, filed Mar. 23, 2010. The sealing action of the cams 9x, 9Ax can occur with no base plate 6x by an opposing cam 9x pressing and pinching the opposing flexible membranes 20Ax and 20Bx together. With no base plate 6x, the supply inlet port 10x can be configured to enter adjacent or through the exhaust tail 26x, or towards the crankshaft end (near 5x) through a fixed set of pinching apparatuses (not shown) that seal the two membranes 20Ax and 20Bx together, in a similar fashion as that described above for the two cams 9x without the base plate 6x.

### OPERATION EXAMPLES

### Idle Operation

Under typical conditions there would be no idling or combustion when the vehicle is stopped, similar to an electric or hybrid vehicle. The whole system would not operate when at a stop, and would remain in a standby mode with the supply of compressed air in the air storage tanks 4, 7 ready for initial acceleration. There may be conditions where the external combustor 1 and low pressure-gradient positive displacement motor will run when the vehicle is at a full stop, for example, when it is necessary for heating or air conditioning, or when it is desired to fill the air storage tanks with compressed air for later use.

### Acceleration

The external combustor 1 is not required to operate during initial acceleration because the energy to accelerate the vehicle from a dead stop could come from the pressurized air in the storage tanks 4,7 similar to the operation of an air motor. After the vehicle gets up to speed, combustion air and fuel can be injected into the igniter manifold 9 and the hot combustion gases can accelerate or maintain constant speed, or provide additional power input to the compressors 3, 6 to fill up the air storage tanks 4, 7.

### Straight & Level Cruise

During straight and level cruise is when the lower pressure compressor 3 and higher pressure compressor 6 are synchronized to provide the exact quantity and flow of compressed air to achieve the most optimum combustion and power output from the external combustor 1. Excluding times when there is a desire to fill or empty the air storage tanks 3, 6, the straight and level cruise situation is where the only power consumed by the “drag” of the compressors is that necessary for sustained combustion at the power output desired, similar to a conventional internal combustion engine, however, with a lot more efficient combustion, energy usage, and no cooling requirements.

### Deceleration

Deceleration, whether going down a hill or braking to a stop, would always be accompanied by engaging the compressors 3, 6 and storing the otherwise wasted stopping energy in the air storage tanks 4, 7. In situations where the storage tanks are already filled, the compressed air could be vented, at least saving the brakes from unneeded wear. The conventional hydraulic brakes would always be maintained as the primary braking power for emergency stops.

The above information describes the general operation of the external combustion apparatus combined with the low pressure-gradient positive displacement motor. In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

What is claimed is:

1. A combustion device producing a pressurized gas to drive an external device, said combustion device comprising:
a combustion vessel having a first inlet provided at the bottom of said combustion vessel, a second inlet and an outlet,
a first device for producing a first pressurized gas stream, said first pressurized gas stream entering said combustion vessel through said first inlet where it is combined with fuel; and
an igniter provided in communication with said first inlet for combusting a mixture of said fuel and said first pressurized gas to produce a primary flame flowing upwardly in said combustion vessel.

2. The combustion device in accordance with claim 1, comprising a second device for producing a second pressurized gas stream, said second pressurized gas stream having a lower pressure than said first pressurized gas stream, said second gas pressurized gas stream entering said combustion vessel through said second inlet position at an upper region of said combustion vessel but lower than said outlet, said second pressurized gas stream combining and combusting with said primary flame to produce a pressurized exhaust gas within said combustion vessel,
wherein said pressurized exhaust gas exits said output for operating a pressure driven device.

3. The combustion device in accordance with claim 2, wherein said combustion vessel is provided with an outer wall and an inner wall forming an annular space for a portion of the height of said combustion vessel, said annular space terminating above the bottom of said combustion vessel, and further wherein said second inlet is in fluid communication with said annular space, allowing said second pressurized gas stream to circumferentially flow downward through said annular space and then exit said annular space above the bottom of said combustion vessel, resulting in said second pressurized gas stream to flow upward in said combustion vessel prior to combining with said primary flame to produce said pressurized exhaust gas.

4. The combustion device in accordance with claim 3, further including a stator nozzle in communication with said igniter, said stator nozzle imparting an angular flow velocity to said primary flame, thereby reducing the pressure of said primary flame to be equal or nearly equal to the pressure of said second pressurized gas stream.

5. The combustion device in accordance with claim 4, wherein said first and second devices are compressors.

6. The combustion device in accordance with claim 5, further including a single transmission device connected to the input of each of said compressors.

7. The combustion device in accordance with claim 6, wherein said single transmission device is provided with a first output shaft connected to one of said compressors and a second output shaft connected to the second compressor.

8. The combustion device in accordance with claim 7, further wherein said pressure driven motor is provided with an output drivetrain connected to the input of said single transmission device.

9. The combustion device in accordance with claim 6, said single transmission device is continuously variable.

10. The combustion device in accordance with claim 2, wherein a portion of said second pressurized gas stream produced by said second device is diverted into said first device for producing said first pressurized gas stream.

11. The combustion device in accordance with claim 10, further including a compressed air cooler connected to said first device is provided to remove heat from the combustion device.

12. The combustion device in accordance with claim 2, further including a combustion conditioner in communication with said outlet, wherein said pressurized exhaust gas is maintained for a period of time to allow said pressurized exhaust gas to become more laminar in flow characteristics.

13. The combustion device in accordance with claim 12, further including a heat exchanger between said combustion conditioner and said pressure driven device.

14. The combustion device in accordance with claim 1, wherein said combustion vessel is provided with a pressure relief device.

15. The combustion device in accordance with claim 2, wherein said pressure driven device is a low pressure positive displacement motor, including a drive member utilizing said pressurized exhaust gas to rotate said drive member.

16. The combustion device in accordance with claim 15, wherein said low pressure positive displacement motor comprises a housing, a drive member, at least one flexible membrane located within the housing so as to divide the interior of the housing into a plurality of chambers, one or more inlets through which said pressurized exhaust gas enters the housing, and one or more outlets through which the pressurized exhaust gas exits the housing, and wherein the at least one membrane is adapted for connection to the drive member such that movement of the pressurized exhaust gas within the housing results in the at least one membrane imparting a force to the drive member.

17. The combustion device in accordance with claim 16, wherein the flexing of the at least one flexible membrane is caused by pressure differentials between the plurality of chambers in the housing.

18. The combustion device in accordance with claim 16, wherein the apparatus comprises a pair of flexible membranes.

19. The combustion device in accordance with claim 18, wherein the pair of flexible membranes are connected at one end to a connecting member, the connecting member being adapted for connection to the drive member.

20. The combustion device in accordance with claim 18, wherein the one or more inlets through which a pressurized fluid enters the housing are located between the pair of flexible membranes.
